(19) United States
(12) Patent Application Publication
(10) Pub. No.: US 2012/0190361 A1
(43) Pub. Date: Jul. 26, 2012

(54) METHOD AND APPARATUS FOR SEARCHING AND SELECTING A PUBLIC LAND MOBILE NETWORK IN A MULTIPLE RADIO ACCESS TECHNOLOGY ENVIRONMENT

(75) Inventors: Asif SHAIKH, Bangalore (IN); Grishma Reddy, Bangalore (IN)

(73) Assignee: Samsung Electronics Co., Ltd.

(21) Appl. No.: 13/356,181

(22) Filed: Jan. 23, 2012

(30) Foreign Application Priority Data
Jan. 21, 2011 (IN) 207/CHE/2011
Jan. 9, 2012 (KR) 10-2012-0002354

(51) Int. Cl. H04W 40/24

(52) U.S. Cl. 455/434

(57) ABSTRACT

A method and device for manual searching and selecting a Public Land Mobile Network (PLMN) in one or more Radio Access Technologies (RATs) is provided, and includes receiving a request from a user of the UE to manually search for a desired PLMN, and performing a manual search for the desired PLMN in one or more RATs supported by the UE based on the request, detecting one or more PLMNs available associated with the one or more RATs during the ongoing manual search, and displaying a list of PLMNs including the one or more available PLMNs associated with the one or more RATs on a display of the UE when the manual search is being performed, where the displayed PLMNs includes the desired PLMN.

### PRIORITY

This application claims priority under 35 U.S.C. §119(a) to an Indian Patent Application filed in the Indian Patent Office on Jan. 21, 2011 and assigned Serial No. IN 207/CHE/2011, and a Korean Patent Application filed in the Korean Intellectual Property Office on Jan. 9, 2012 and assigned Serial No. 10-2012-0002354, the content of each of which are incorporated herein by reference.

### BACKGROUND OF THE INVENTION

1. Background of the Invention

The present invention relates generally to the field of telecommunication, and more particularly, to manual searching of a Public Land Mobile Network (PLMN).

2. Description of the Related Art

Typically, a UEEquipment (UE) in a telecommunications network initiates a cell search of a specific PLMN in a specific Radio Access Technology (RAT). The UE may perform an automatic cell search or a manual cell search to camp on the specific PLMN. In the automatic cell search, the UE automatically selects a high priority PLMN found in the radio environment for camping. The priority order of PLMN is followed as per Third Generation Partnership Project (3GPP) Technical Specification (TS) 23.122. In the manual cell search, a list of available PLMNs is provided on a display of the UE, such that the user of the UE may manually select a PLMN from the list of available PLMNs. Based on the selection, a radio signaling is performed between the UE and a network equipment to register for normal services.

Currently, in the manual mode, a full band search in the supported RATs is performed by the UE supporting multiple RATs and a consolidated list of PLMNs is displayed by the UE upon completion of the full band search in the supported RATs. For example, a full band search is initially performed in an active RAT and subsequently in passive RATs. With the UE supporting a number of radio access technologies such as Global System for Mobile Communications (GSM), Universal Mobile Telecommunications System (UMTS), and Long Term Evolution (LTE), the full band manual search may require a longer time than expected by the user of the UE. Hence, the user has to wait for a desired PLMN until the entire full band search is complete, thereby causing a delay in selection of the desired PLMN and significant consumption of battery power.

### SUMMARY OF THE INVENTION

The present invention provides a method and apparatus for manually searching and selecting a PLMN in a multiple RAT environment.

In one aspect, a method of an UE for manually searching a PLMN in one or more radio access technologies RATs includes receiving a request from a user of the UE to manually search for a desired PLMN, and performing a manual search for the desired PLMN in one or more RATs supported by the UE based on the request, detecting one or more available PLMNs associated with the one or more RATs during the manual search for the desired PLMN, and displaying a list of PLMNs including the one or more available PLMNs associated with the one or more RATs on a display of the UE when the manual search for the desired PLMN is being performed.

In yet another aspect, a UE includes a processor and memory coupled to the processor. The memory includes a PLMN search and selection module for receiving a request from a user of the UE to manually search for a desired PLMN, and performing a manual search for the desired PLMN in one or more RATs supported by the UE based on the request. The PLMN search and selection module detects one or more available PLMNs associated with the one or more RATs during the manual search for the desired PLMN, and displays a list of PLMNs including the one or more available PLMNs associated with the one or more RATs on a display of the UE when the manual search for the desired PLMN is being performed.

### BRIEF DESCRIPTION OF THE DRAWINGS

FIG. 1 illustrates a method of manually searching and selecting a PLMN by a UE, according to an embodiment of the present invention.

FIG. 2 illustrates a method of performing a manual search for a desired PLMN in one or more RATs, according to an embodiment of the present invention.

FIGS. 3A through 3G are user interface views of a UE illustrating a process of efficient manual searching of a PLMN, according to the present invention.

FIG. 4 illustrates a UE for performing embodiments of the present invention.

### DETAILED DESCRIPTION OF EMBODIMENTS OF THE INVENTION

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

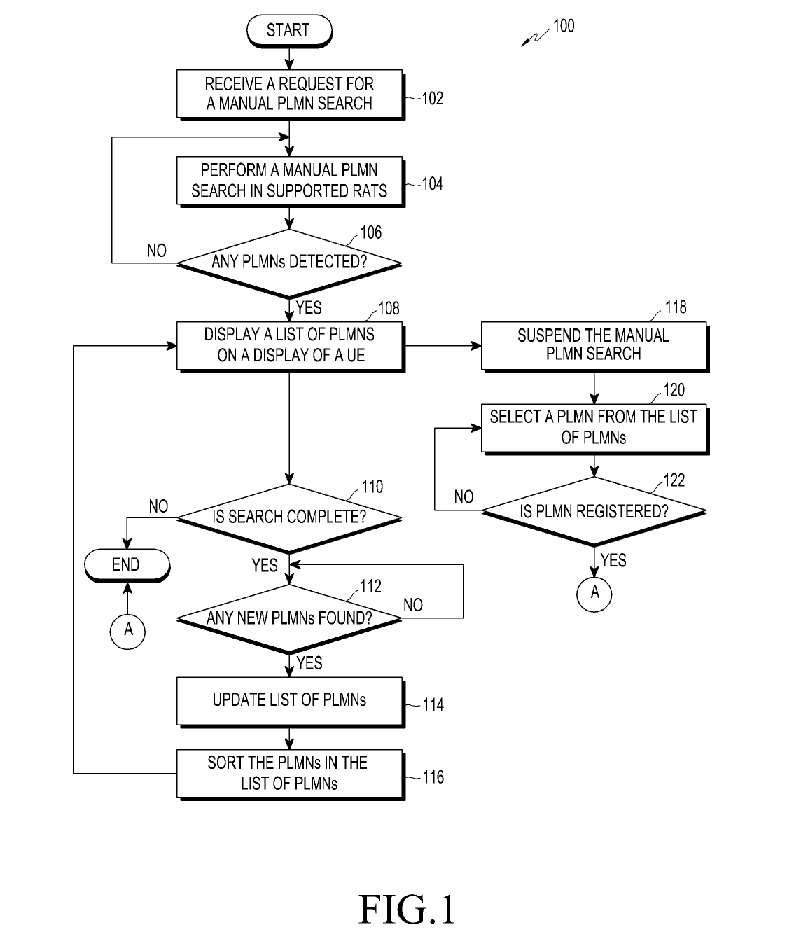

FIG. 1 is a flow chart 100 of a method of manually searching and selecting of a PLMN, according to an embodiment of the present invention. At step 102, a request for manually searching a desired PLMN is received from a user of a UE. At step 104, a manual search for the desired PLMN is performed in one or more RATs supported by the UE. In one embodiment, one or more frequencies corresponding to PLMNs in a frequency band group belonging to each of the one or more RATs are scanned to search for available PLMNs, as will be described later in the description. At step 106, it is determined whether any PLMNs associated with one or more RATs are detected during the manual search. If any PLMNs are found, then at step 108 a list of PLMNs including one or more PLMNs is displayed on a display of the UE when the manual search is being performed by the UE; otherwise, the manual search for the desired PLMN is continued.

In one embodiment, the list of PLMNs is displayed in dim and translucent format as the manual search is in progress. At step 110, it is determined whether the manual search is complete. If the manual search is in progress, then it is determined whether any PLMNs are found as the manual search progresses, at step 112.

If it is determined that any PLMNs are found, then at step 114, the list of PLMNs is updated with the new PLMNs. In one embodiment, it is determined whether one or more of the PLMNs found are already present in the list of PLMNs. If so, the one or more of the PLMNs are not utilized; otherwise, the one or more of the PLMNs are added to the list of PLMNs. At step 116, the PLMNs in the list of PLMNs are sorted based on highest order priority for displaying the PLMNs as specified in 3GPP TS 23.122. The process is then routed to step 108 in which the sorted list of PLMNs is displayed on the display of the UE. Steps 110-116 are repeated until the manual search is complete, suspended, or terminated upon registration of the PLMN.

If the displayed list of PLMNs includes the PLMN on which camping is desired, then at step 118 the manual search for the desired PLMN is suspended by the user, at which time the list of PLMNs found is displayed to the user in order to allow the user to select the desired PLMN from the list of PLMNs. At step 120, a PLMN is selected from the list of PLMNs including one or more PLMNs and registration of the UE with the selected PLMN is performed. At step 122, it is determined whether the UE is successfully registered with the selected PLMN. If the selected PLMN is successfully registered, the manual search for the desired PLMN is terminated. If the selected PLMN is not registered, then the previous list of PLMNs is displayed on the UE and the user is allowed to select another available PLMN from the list of PLMNs, at step 120. Alternatively, the manual search is resumed by the user and the process 100 is routed to perform steps 110-116 described above.

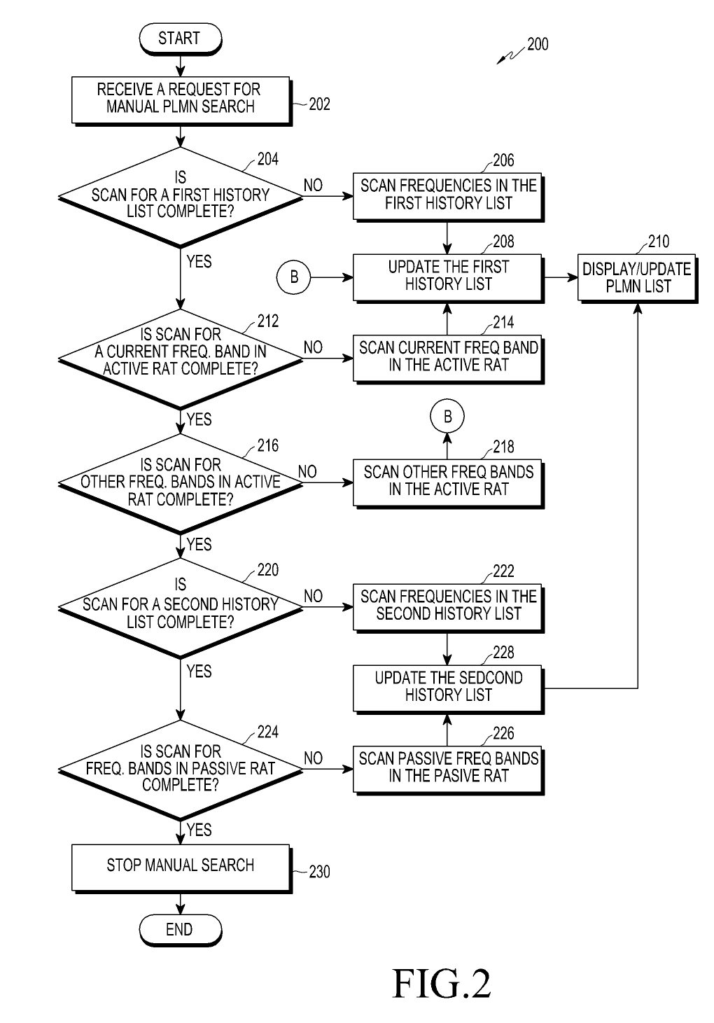

FIG. 2 illustrates a method of performing a manual search for a desired PLMN in one or more RATs, according to an embodiment of the present invention. The process 200 illustrates in detail the process of step 104 of FIG. 1. At step 202, a request to perform a manual search is received from the user of the UE. At step 204, it is determined whether frequencies in an active RAT history list (hereinafter, history list M1) stored in the memory of the UE are scanned. The history list M1 includes frequencies associated with PLMNs of an active RAT (currently camped on by the UE) stored as per frequency bands. If the frequencies in the history list M1 are not scanned, then at step 206, the frequencies in the history list M1 are scanned. At step 210, a list of PLMNs is displayed instantly on the display of the UE based on scanning of the frequencies in the history list M1. This scanning can be particularly beneficial if the user has triggered a manual search in the same area where the UE was previously registered.

If the frequencies in the history list are scanned, at step 212, it is determined whether a current frequency band associated with the active RAT is scanned. If the current frequency band is not scanned, then at step 214, the current frequency is scanned by the UE, and duplicate entries of the PLMNs are filtered from the list of PLMNs. The displayed list of PLMNs is updated with new PLMNs and is sorted out based on the display priority specified in 3GPP TS 23.122 at step 210.

If the current frequency band is scanned, then at step 216, it is determined whether other frequency bands in the active RAT are scanned. If the other frequency bands in the active RAT are not scanned, then at step 218, the other frequency bands in the active RAT are scanned by the UE. The displayed list of PLMNs is updated with any new PLMNs and is sorted out based on the display priority specified in 3GPP TS 23.122, at step 210. The history list M1 is updated with frequencies associated with any new PLMNs found during scanning in steps 206, 214 and 218, as in step 208.

Upon completing the scan associated with the active RATs, the UE switches the RAT from active to passive (supported by the UE). At step 220, it is determined whether frequencies in a second history list (hereinafter, history list M2) stored in the memory of the UE are scanned. The history list M2 includes frequencies associated with PLMNs of the passive RAT stored as per frequency bands associated with the passive RAT. If more than one passive RAT is supported by the UE, one separate history list is maintained for each passive RAT. If the frequencies in the history list M2 are not scanned, then at step 222, the frequencies in the history list M2 are scanned. The displayed list of PLMNs is updated with new PLMNs found during scanning and the updated list of PLMNs is sorted out based on the display priority specified in 3GPP TS 23.122, at step 210.

If the other frequency bands are scanned, then at step 224, it is determined whether all frequency bands in the passive RAT are scanned. If the frequency bands in the passive RAT are not scanned, then at step 226, the frequency bands in the passive RAT are scanned by the UE. The displayed list of PLMNs is updated with new PLMNs found at step 226 and the updated list of PLMNs is sorted out based on the display priority specified in 3GPP TS 23.122, at step 210. The history list M2 is updated with frequencies associated with any new PLMNs found during scanning in steps 222 and 226, as in step 228. The history list M1 and the history list M2 are maintained based on the priority order specified in 3GPP TS 23.122 such that one or more frequencies for a Home PLMN [HPLMN] are given more priority for retaining the frequencies in the history lists M1 and M2 compared to one or more frequencies associated with a Forbidden PLMN [FPLMN]. For example, if four frequencies of the HPLMN and four frequencies of the FPLMN are found during the scanning process, then while storing the frequencies in the history list M1 or M2 of size six, four frequencies of the HPLMN and two frequencies of the FPLMN are stored as the probability is more likely that the user will select the HPLMN or any other preferred PLMN as compared to the user selecting the FPLMN.

If the frequency bands in the passive RAT are scanned, it implies that the manual search is complete and hence the manual search is stopped, at step 230. Although the above method describes scanning of a frequency band associated with a single passive RAT, one can envision that the UE can scan all the passive RATs supported by the UE during the manual search.

Moreover, the methods of FIGS. 1 and 2 may be realized by a non-transitory computer-readable storage medium having instructions to manually search and select a PLMN in multiple RAT environments stored therein, that is executed by the UE.

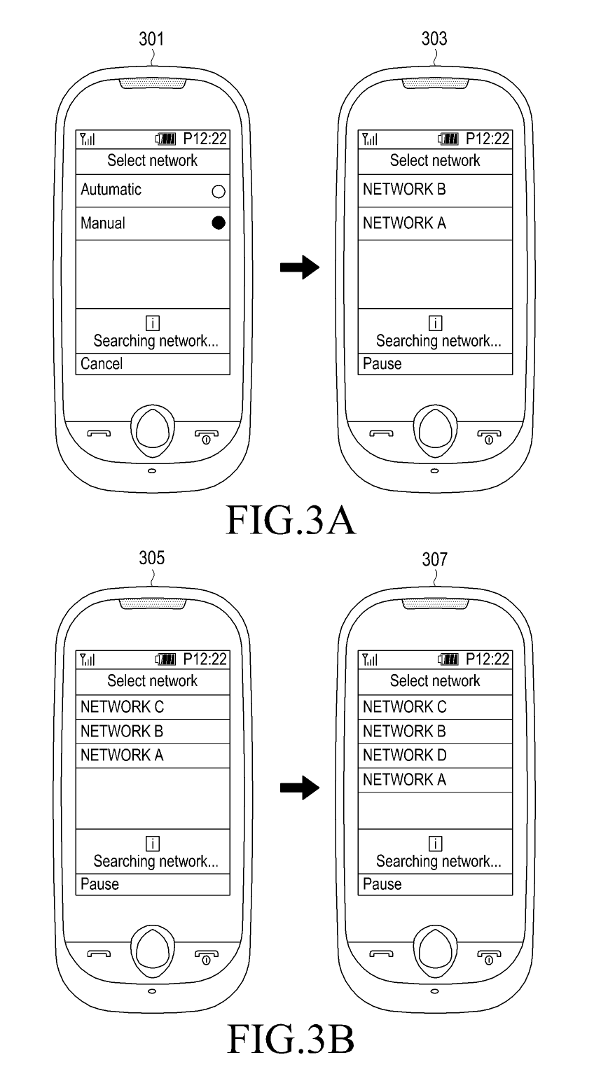

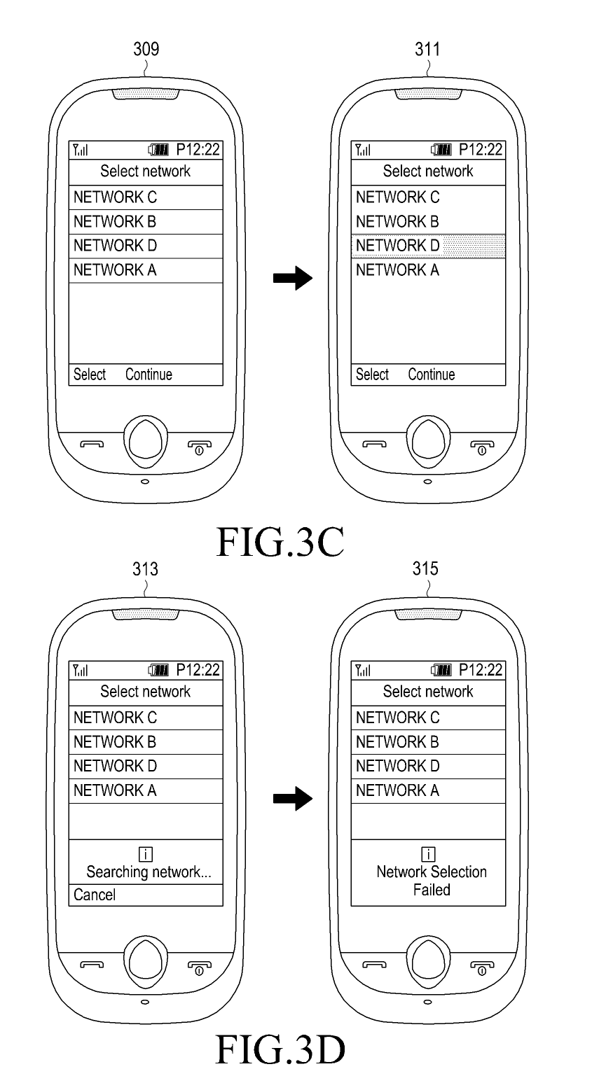

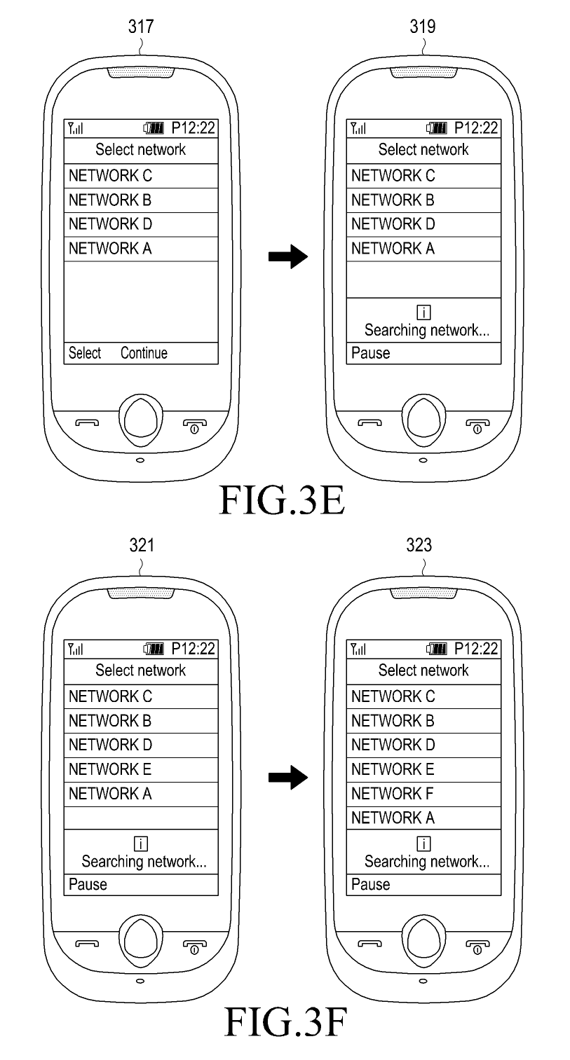

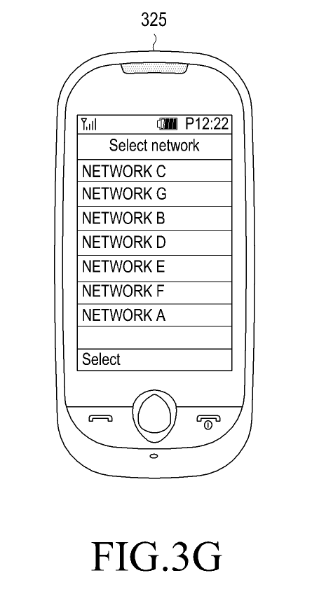

FIGS. 3A through 3G are user interface views of a UE illustrating efficient manual searching of a PLMN, according to the present invention. Suppose that when the UE is powered on or experiences a recovery from a out of service area, limited service or a home PLMN timer expires, and the user may trigger a manual search using a manual search option in the UE as illustrated by a screen 301. Accordingly, the UE scans frequencies in the history list M1 to determine whether any PLMNs are available. It is noted that the history list is associated with the active RAT camped by the UE before the manual search. If any PLMNs associated with the frequencies are found available, the UE displays a list of PLMNs on a display of the UE. As shown in screen 303 of FIG. 3A, the UE found the PLMNs as Network A and Network B. In one embodiment, the list of PLMNs displayed on the UE is sorted based on the priority specified in 3GPP TS 23.122. Since, the manual search is in progress, the display of the UE displays the list of PLMNs in lower background light.

Further, the UE scans each supported frequency band associated with the active RAT and any new PLMNs found during the scanning operation are updated in the list of PLMNs. For example, consider that in the active RAT (GSM), the UE supports frequency bands 850 MHz, 900 MHz, 1800 MHz, and 1900 MHz and the UE is camped on 900 MHz frequency band. In this case, the UE scans the 900 MHz frequency band and detects available PLMNs as Network C and Network B. Since Network B was found during scanning of the frequencies from the history list M1, the UE adds Network C into the list of PLMNs displayed as shown in screen 305 of FIG. 3B. In one embodiment, the list of PLMNs displayed on the UE is sorted based on the priority specified in 3GPP TS 23.122. Since the manual search is still in progress, the display of the UE displays the list of PLMNs in lower background light.

The UE then scans the 850 MHz frequency band of the active RAT and does not detect any PLMNs, hence the list of PLMNs is not updated. Further, the UE scans the 1800 MHz frequency band of the active RAT and detects available PLMNs as Network A and Network D. Since Network A was found during scanning of the frequencies from the history list M1, the UE adds Network D into the list of PLMNs displayed as shown in screen 307 of FIG. 3B. The UE then scans the 1900 MHz frequency band of the active RAT and does not detect any PLMNs, hence the list of PLMNs is not updated. The history list M1 associated with the active RAT is updated with the frequencies associated with the detected PLMNs during the frequency band search of the active RAT. The history list M1 is also updated in real time during power ON search or when the UE recovers from out of service area or limited service, or when a home PLMN timer expires.

As Network D is displayed in the list of PLMNs, the user suspends the ongoing manual search using a pause option. The UE displays the list of PLMNs clearly on the display and allows the user to select a desired PLMN (e.g., Network D) from the list of PLMNs for camping as shown in screen 309 of FIG. 3C. As shown in screen 311 of FIG. 3C, the user selects Network D from the list of PLMNs. The UE performs registration with Network D and displays the status as ‘selecting a network’ during the registration process as shown in screen 313. As shown in screen 315 of FIG. 3D, the UE fails to register the user selected PLMN (i.e., Network D), as indicated by the ‘network selection failed’ pop-up on the display of the UE.

Since the manual registration failed, the UE displays the list of PLMNs found during the suspended manual search on the display as illustrated in screen 317 of FIG. 3E. The UE allows the user to select another PLMN from the list of PLMNs using a ‘select’ option or resume the suspended manual search using a ‘continue’ option. As shown in screen 319 of FIG. 3E, the user selects the ‘continue’ option and the UE resumes the suspended manual search from the point of suspension.

Since the frequency bands in the active RAT are scanned, the UE may switch from the active RAT to a passive RAT, such as UMTS. The UE quickly scans frequencies in a history list M2 to determine whether any PLMN associated with the frequencies is available. The UE finds PLMNs as Network D, Network B, and Network A during the manual search. Since Network D and Network A are present in the list of PLMNs, the UE adds Network B to the list of PLMNs. The list is sorted based on priority and displayed on the UE.

Further, the UE scans each supported frequency band associated with the active RAT and any new PLMNs found during the scanning operation are updated in the list of PLMNs. Consider that in the passive RAT (UMTS), the UE supports frequency bands 900 MHz and 2100 MHz, and the UE is camped on 900 MHz frequency band. In this case, the UE scans the 900 MHz frequency band and detects available PLMNs as Network A, Network E, and Network D. Since, Network D and Network A were found during scanning of the frequencies from the history list M2, the UE adds Network E to the list of PLMNs. In one embodiment, the list of PLMNs displayed on the UE is sorted based on priority specified in 3GPP TS 23.122. Since the manual search is still in progress, the display of the UE displays the list of PLMNs in lower background light as shown in screen 321 of FIG. 3F.

The UE then scans the 2100 MHz frequency band of the passive RAT and detects the available PLMNs as Network F and Network B. Since Network B is present in the list of PLMNs, Network F is added to the list of PLMNs and the list is sorted and displayed on the UE as shown in screen 323 of FIG. 3F. Accordingly, the UE updates the history list M2 associated with the passive RAT with the frequencies associated with the detected PLMNs during the manual search associated with the passive RAT. The history list M2 is also updated in real time when the UE recovers from out of service area or limited service, or when the home PLMN timer expires. The UE thus displays the list of the PLMNs available clearly as the manual search is complete and the user is allowed to select a desired PLMN from the list of the PLMNs as illustrated in screen 325 of FIG. 3G. If the UE has successfully registered with Network D upon suspending the manual search as shown in screen 309, then the manual search is aborted, and the UE does not perform the manual search associated with the passive RAT. This is a simplified manual search and selection of the desired PLMN for the user, and also conserves battery power.

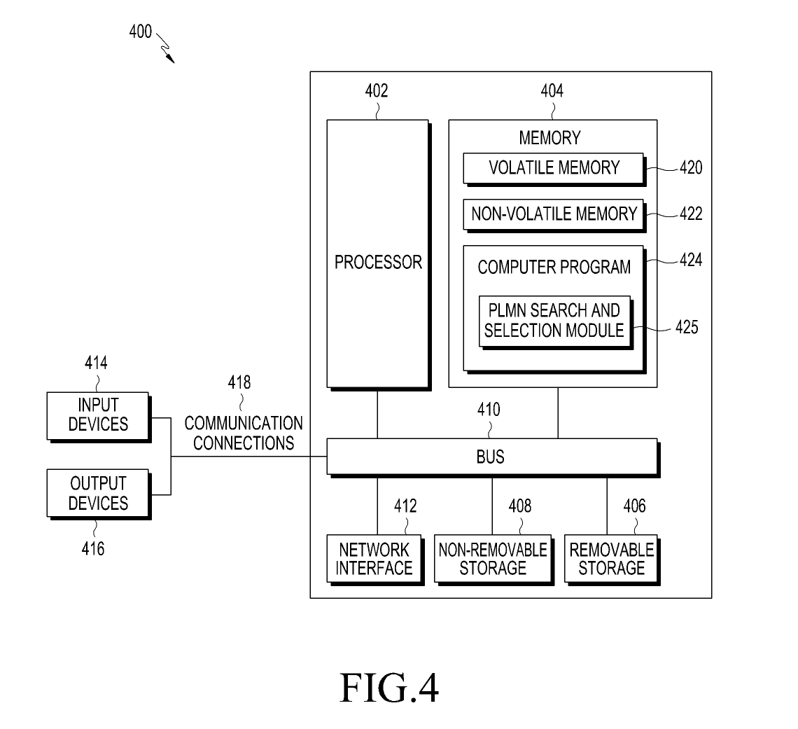

FIG. 4 illustrates a UE for performing embodiments of the present invention.

The UE 400, such as a mobile station, personal digital assistant, or smart phone, may include a processor 402, memory 404, a removable storage 406, and a non-removable storage 408. The UE 400 additionally includes a bus 410 and a network interface 412. The UE 400 may include or have access to one or more user input devices 414, one or more output devices 416, and one or more communication connections 418 such as a network interface card or a Universal Serial Bus (USB) connection. The one or more user input devices 414 may be a keyboard or a mouse. The one or more output devices 414 may be a display of the UE 400. The communication connections 418 include, for example, wide area network and radio frequency network.

The memory 404 may include volatile memory 420 and non-volatile memory 422. A variety of computer-readable storage media may be stored in and accessed from the memory elements of the UE 400, such as the volatile memory 420 and the non-volatile memory 422, the removable storage 404 and the non-removable storage 408. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and Memory Sticks™.

The processor 402, as used herein, includes any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 404 may also include embedded controllers, such as generic or programmable logic devices or arrays, application specific integrated circuits, single-chip computers, and smart cards.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 402 of the UE 400. For example, a computer program 424 may include a PLMN searching and selection module 425 in the form of machine-readable instructions capable of manually searching one or more PLMNs in one or more RATs, according to embodiments of the present invention, such as steps described in FIGS. 1 and 2. In one embodiment, the computer program 424 may be included on a compact disk-read only memory (CD-ROM) and loaded from the CD-ROM to a hard drive in the non-volatile memory 422. The machine-readable instructions may cause the UE 400 to encode according to embodiments of the present invention.

Particularly, when a request for manually searching a desired PLMN is received from a user of a UE, the PLMN searching and selection module 425 performs a manual search for the desired PLMN in one or more RATs supported by the UE. In one embodiment, the PLMN searching and selection module 425 scans one or more frequencies corresponding to PLMNs in a frequency band group belonging to each of the one or more RATs.

The PLMN searching and selection module 425 determines whether any PLMNs associated with one or more RATs are detected during the manual search. If any one PLMN is not detected, the PLMN searching and selection module 425 continually performs the manual search.

If any one PLMN is detected, the PLMN searching and selection module 425 displays a list of PLMNs including one or more detected PLMNs on a display of the UE, and determines whether the manual search is complete. If the manual search is completed, the PLMN searching and selection module 425 completes a process of the manual search, and determines whether one or more PLMNs is detected in the process.

When it is determined that any one PLMN is detected, the PLMN searching and selection module 425 updates the list of PLMNs with the new PLMN. In one embodiment, the PLMN searching and selection module 425 determines whether one or more PLMNs detected are already present in the list of PLMNs. If so, the PLMN searching and selection module 425 ignores the one or more PLMNs. Otherwise, the PLMN searching and selection module 425 adds the one or more PLMNs to the list of PLMNs.

The PLMN searching and selection module 425 arranges the PLMNs in the list of PLMNs based on highest order priority for displaying the PLMNs as specified in 3GPP TS 23.122, and displays the list of PLMNs.

When the displayed list of PLMNs includes the PLMN on which camping is desired, if the user requests a suspension or a pause for the manual search of PLMN, the PLMN searching and selection module 425 suspends or pause the manual search. Once the manual search is suspended or paused, the PLMN searching and selection module 425 displays clearly the list of PLMNs detected in order to allow the user to select the desired PLMN from the list of PLMNs.

When a PLMN is selected from the list of PLMNs including one or more PLMNs by the user, the PLMN searching and selection module 425 performs registration of the UE with the selected PLMN. The PLMN searching and selection module 425 determines whether the UE is successfully registered with the selected PLMN. If the selected PLMN is successfully registered, the PLMN searching and selection module 425 terminates the manual search for the desired PLMN. If the selected PLMN is not registered, the PLMN searching and selection module 425 displays the previous list of PLMNs in order to allow selection of another available PLMN from the list of PLMNs.

A process for the manual searching of the desired PLMN is performed as follows.

When a request to perform a manual search is received from the user of the UE, the PLMN searching and selection module 425 determines whether frequencies in a history list M1 stored in memory of the UE are scanned. The history list M1 includes frequencies associated with PLMNs of an active RAT (currently camped on by the UE) stored as per frequency bands.

If the frequencies in the history list M1 are not scanned, the PLMN searching and selection module 425 scans the frequencies in the history list M1 and updates the history list M1 with the frequencies with respect to the detected PLMN. The PLMN searching and selection module 425 generates the PLMN list based on a scanning result of the frequencies included in the history list M1, and displays the generated PLMN list. The displayed list of PLMNs is updated with new PLMNs and is sorted out based on the display priority specified in 3GPP TS 23.122.

If the frequencies in the history list are scanned, the PLMN searching and selection module 425 determines whether a current frequency band associated with the active RAT is scanned. If the current frequency band is not scanned, the PLMN searching and selection module 425 scans the current frequency, and updates the history list M1 with the frequencies with respect to the detected PLMN. The PLMN searching and selection module 425 generates the PLMN list based on a scanning result of the current frequency band, and displays the generated PLMN list. Further, duplicate entries of the PLMNs are filtered from the list of PLMNs. The displayed list of PLMNs is updated with new PLMNs and is sorted out as per display priority specified in 3GPP TS 23.122 at step 210 of FIG. 2.

If the current frequency band is scanned, the PLMN searching and selection module 425 determines whether other frequency bands in the active RAT are scanned. If the other frequency bands in the active RAT are not scanned, the PLMN searching and selection module 425 scans the other frequency bands in the active RAT, and updates the history list M1 with the frequencies with respect to the detected PLMN. The PLMN searching and selection module 425 generates the PLMN list based on a scanning result of the other frequency bands, and displays the generated PLMN list.

If the other frequencies are scanned, the PLMN searching and selection module 425 determines that a scanning of the frequency band with respect to the active RAT is completed, and switches the RAT from the active RAT to a passive RAT (supported by the UE).

The PLMN searching and selection module 425 determines whether frequencies in a history list M2 stored in memory are scanned. The history list M2 includes frequencies associated with PLMNs of the passive RAT stored based on frequency bands associated with the passive RAT.

If the frequencies in the history list M2 are not scanned, the PLMN searching and selection module 425 scans the frequencies in the history list M2, and updates the history list M2 with the frequencies with respect to the detected PLMN. The PLMN searching and selection module 425 generates the PLMN list based on a scanning result of the frequencies included in the history list M2, and displays the generated PLMN list.

If the other frequency bands are scanned, the PLMN searching and selection module 425 determines whether all frequency bands in the passive RAT are scanned. If the frequency bands in the passive RAT are scanned, the PLMN searching and selection module 425 determines that the manual searching is completed, and suspends the manual searching.

If the frequency bands in the passive RAT are not scanned, the PLMN searching and selection module 425 scans the frequency bands in the passive RAT, and updates the history list M2 with the frequencies with respect to the detected PLMN. The PLMN searching and selection module 425 generates the PLMN list based on a scanning result of the frequency bands in the passive RAT, and displays the generated PLMN list.

The various devices, modules, analyzers, generators, and other equipment described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as an application specific integrated circuit.

Although the present invention has been described with reference to specific embodiments, it will be evident that various modifications and changes may be made to these embodiments without departing from the broader spirit and scope of the present invention.

What is claimed is:

1. A method of a User Equipment (UE) for manually searching a Public Land Mobile Network (PLMN) in one or more Radio Access Technologies (RATs), comprising:
receiving a request from a user of the UE to manually search for a desired PLMN;
performing a manual search for the desired PLMN in one or more RATs supported by the UE based on the request;
detecting one or more available PLMNs associated with the one or more RATs during the manual search for the desired PLMN; and
displaying a list of PLMNs including the one or more available PLMNs associated with the one or more RATs on a display of the UE when the manual search for the desired PLMN is being performed.

2. The method of claim 1, further comprising:
updating the list of PLMNs including the one or more detected PLMNs during the manual search for the desired PLMN;
sorting the one or more PLMNs in the updated list of PLMNs as per highest order of priority for displaying the one or more PLMNs; and
displaying the sorted list of PLMNs on the display of the UE when the manual search for the desired PLMN is being performed.

3. The method of claim 2, wherein updating the list of PLMNs including the one or more detected PLMNs as the manual search for the desired PLMN progresses comprises:
determining whether the one or more PLMNs detected during the manual search for the desired PLMN are present in the displayed list of PLMNs;
ignoring, when the one or more PLMNs are present in the displayed list of PLMNs, the one or more detected PLMNs; and
updating, when the one or more PLMNs are not present in the displayed list of PLMNs, the list of PLMNs including the one or more detected PLMNs as the manual search for the desired PLMN progresses.

4. The method of claim 2, wherein in sorting the one or more PLMNs in the updated list of PLMNs, the highest order of priority for displaying the one or more PLMNs is determined as specified in Third Generation Partnership Project (3GPP) Technical Specification (TS) 23.122.

5. The method of claim 1, further comprising:
suspending the manual search for the desired PLMN associated with the one or more RATs when the displayed list of PLMNs includes the desired PLMN by the user;
selecting the desired PLMN from the list of PLMNs displayed on the display of the UE by the user;
determining whether the UE is successfully registered with the PLMN selected by the user;
manually selecting, if the UE is not successfully registered with the PLMN selected by the user, another PLMN from the list of PLMNs or resuming the manual search for the desired PLMN associated with the one or more RATs; and
terminating, if the UE is successfully registered with the PLMN selected by the user, the manual search for the desired PLMN in the one or more RATs.

6. The method of claim 1, wherein performing the manual search for the desired PLMN in the one or more RATs supported by the UE comprises:
scanning one or more frequencies associated with one or more PLMNs in a frequency band group belonging to each of the one or more RATs, wherein a frequency band group includes one or more frequency bands.

7. The method of claim 6, wherein scanning the one or more frequencies associated with the one or more PLMNs in the frequency band group belonging to each of the one or more RATs comprises:
scanning one or more frequencies corresponding to one or more PLMNs from an active RAT history list of frequencies stored in memory of the UE, wherein the active RAT history list of frequencies comprises frequencies associated with supported frequency bands in one of the one or more RATs currently being used by the UE;
displaying a list of PLMNs including PLMNs detected during scanning of the one or more frequencies in the active RAT history list on the display of the UE;
scanning one or more frequency bands associated with said one of the one or more RATs; and
updating the list of PLMNs displayed on the display of the UE upon scanning each of the one or more frequency bands associated with said one of the one or more RATs.

8. The method of claim 7, wherein scanning the one or more frequencies in a frequency band group associated with each of the one or more RATs further comprises:
scanning one or more frequencies corresponding to one or more PLMNs from a passive RAT history list of frequencies stored in the memory of the UE, wherein the passive RAT history list of frequencies comprises the one or more frequencies associated with supported frequency bands in corresponding one of the remaining one or more RATs supported by the UE;
updating the list of PLMNs displayed on the display of the UE upon scanning the one or more frequencies in the passive RAT history list;
scanning one or more frequency bands associated with the remaining one or more RATs; and
updating the list of PLMNs displayed on the display of the UE upon scanning each of the one or more frequency bands associated with the remaining one or more RATs.

9. The method of claim 8, further comprising:
identifying one or more available PLMNs upon scanning each of the one or more of the frequencies and the one or more frequency bands associated with the one of the one or more RATs and the remaining one or more RATs, respectively;
filtering one or more frequencies associated with the one or more available PLMNs present in the active RAT history list of frequencies and the passive RAT history list of frequencies; and
updating the active RAT history list of frequencies and the passive RAT history list of frequencies with one or more frequencies associated with the one or more PLMNs not present in the active RAT history list of frequencies and the passive RAT history list of frequencies.

10. The method of claim 9, wherein updating the active RAT history list of frequencies and the passive RAT history list of frequencies with the one or more frequencies associated with the one or more PLMNs not present in the active RAT history list of frequencies and the passive RAT history list of frequencies comprises:
determining priority associated with the one or more frequencies corresponding to the one or more PLMNs in the active RAT history list and the passive RAT history list, respectively; and
retaining the one or more frequencies corresponding to the one or more PLMNs in the active RAT history list and the passive RAT history list, respectively, based on the determined priority, wherein a higher priority is considered for a suitable PLMN compared to any other acceptable PLMNs.

11. A User Equipment (UE) for manually searching a Public Land Mobile Network (PLMN) in one or more Radio Access Technologies (RATs) comprising:
a processor; and
a memory coupled to the processor, wherein the memory includes a search and selection module for:
receiving a request from a user of the UE to manually search for a desired PLMN;
performing a manual search for the desired PLMN in one or more RATs supported by the UE based on the request;
detecting the one or more PLMNs available associated with the one or more RATs during the manual search for the desired PLMN; and
displaying a list of PLMNs including the one or more available PLMNs associated with the one or more RATs on a display of the UE when the manual search for the desired PLMN is being performed.

12. The UE of claim 11, wherein the PLMN search and selection module updates the list of PLMNs including the one or more detected PLMNs as the manual search for the desired PLMN progresses, sorts the one or more PLMNs in the updated list of PLMNs based on highest order of priority for displaying the one or more PLMNs, and displays the sorted list of PLMNs on the display of the UE when the manual search for the desired PLMN is being performed.

13. The UE of claim 12, wherein the PLMN search and selection module updates the list of PLMNs including the one or more detected PLMNs during the manual search for the desired PLMN by determining whether the one or more PLMNs detected during the manual search for the desired PLMN are present in the displayed list of PLMNs, ignoring the one or more detected PLMNs if the one or more detected PLMNs are present in the displayed list of PLMNs, and updating the list of PLMNs including the one or more detected PLMNs as the manual search for the desired PLMN progresses if the one or more detected PLMNs are not present in the displayed list of PLMNs.

14. The UE of claim 12, wherein the highest order of priority for displaying the one or more PLMNs is determined as specified in Third Generation Partnership Project (3GPP) Technical Specification (TS) 23.122.

15. The UE of claim 11, wherein the PLMN search and selection module allows the user to suspend the manual search for the desired PLMN associated with the one or more RATs when the displayed list of PLMNs includes the desired PLMN, allows the user to select the desired PLMN from the list of PLMNs displayed on the display of the UE, determines whether the UE is successfully registered with the PLMN selected by the user, allows the user to select another PLMN from the list of PLMNs or resume the manual search for the desired PLMN associated with the one or more RATs if the UE is not successfully registered, and terminates the manual search for the desired PLMN in the one or more RATs if the UE is successfully registered.

16. The UE of claim 11, wherein the PLMN search and selection module performs the manual search for the desired PLMN in the one or more RATs supported by the UE by scanning one or more frequencies associated with one or more PLMNs in a frequency band group belonging to each of the one or more RATs, wherein a frequency band group includes one or more frequency bands.

17. The UE of claim 16, wherein the PLMN search and selection module scans the one or more frequencies associated with the one or more PLMNs in the frequency band group belonging to each of the one or more RATs by scanning one or more frequencies corresponding to one or more PLMNs from an active RAT history list of frequencies stored in the memory of the UE, displaying a list of PLMNs including PLMNs detected during scanning the one or more frequencies in the active RAT history list on the display of the UE, scanning one or more frequency bands associated with said one of the one or more RATs, and updating the list of PLMNs displayed on the display of the UE upon scanning each of the one or more frequency bands associated with said one of the one or more RATs, wherein the active RAT history list of frequencies comprises frequencies associated with supported frequency bands in one of the one or more RATs currently being used by the UE.

18. The UE of claim 17, wherein the PLMN search and selection module further scans the one or more frequencies associated with the one or more PLMNs in the frequency band group belonging to each of the one or more RATs by scanning one or more frequencies corresponding to one or more PLMNs from a passive RAT history list of frequencies stored in the memory of the UE, updating the list of PLMNs displayed on the display of the UE upon scanning the one or more frequencies in the passive RAT history list, scanning one or more frequency bands associated with the remaining one or more RATs, and updating the list of PLMNs displayed on the display of the UE upon scanning each of the one or more frequency bands associated with said remaining of the one or more RATs, wherein the passive RAT history list of frequencies comprises the one or more frequencies associated with supported frequency bands in corresponding one of the remaining one or more RATs supported by the UE.

19. The UE of claim 18, wherein the PLMN search and selection module identifies one or more available PLMNs upon scanning each of the one or more of the frequencies and the one or more frequency bands associated with said one of the one or more RATs and the remaining one or more RATs, respectively, filters one or more frequencies associated with the one or more available PLMNs present in the active RAT history list of frequencies and the passive RAT history list of frequencies, and updates the active RAT history list of frequencies and the passive RAT history list of frequencies with one or more frequencies associated with the one or more PLMNs not present in the active RAT history list of frequencies and the passive RAT history list of frequencies.

20. The UE of claim 19, wherein the PLMN search and selection module updates the active RAT history list of frequencies and the passive RAT history list of frequencies with the one or more frequencies associated with the one or more PLMNs not present in the active RAT history list of frequencies and the passive RAT history list of frequencies by determining priority associated with the one or more frequencies corresponding to the one or more PLMNs in the active RAT history list and the passive RAT history list, respectively, and retaining the one or more frequencies corresponding to the one or more PLMNs in the active RAT history list and the passive RAT history list, respectively, based on the determined priority, wherein a higher priority is considered for a suitable PLMN compared to any other acceptable PLMNs.
